(19) United States
(12) Patent Application Publication
(10) Pub. No.: US 2011/0137451 A1
(43) Pub. Date: Jun. 9, 2011

(54) Method for Modeling a Control Circuit for a Processing Machine

(75) Inventors: Stephan Schultze, Lohr-Wombach (DE); Holger Schnabel, Veitshoechheim (DE)

(73) Assignee: ROBERT BOSCH GMBH, Stuttgart (DE)

(21) Appl. No.: 13/056,605

(22) PCT Filed: Jun. 19, 2009
(86) PCT No.: PCT/EP09/04426

§ 371 Date: Feb. 8, 2011

(30) Foreign Application Priority Data
Jul. 31, 2008 (DE) 10 2008 035 639.5

(51) Int. Cl. B65H 43/00; B41F 33/00; G06F 19/00; G06F 7/60

(52) U.S. Cl. 700/213; 703/2

(57) ABSTRACT

The invention relates to modeling a control circuit (300) for a processing machine for processing a material web, particularly shaft-less printing machine, wherein at least one dead time (T_{t,SENSOR}, T_{t,NET}, T_{t,SPS}, T(v)_{R}, T(v)_{D}) is taken into consideration during modeling.

The present invention relates to a method for modeling a control loop for a processing machine, an appropriately designed computation unit, an appropriate computer program, and an appropriate computer program product.

Although the following text refers mainly to printing machines, the invention is not restricted to them but in fact relates to all types of processing machines in which a material web is processed. However, the invention can be used in particular for printing machines such as, for example, newspaper printing machines, job printing machines, gravure printing machines, packaging printing machines or valuable-document printing machines as well as for processing machines such as, for example, bag insertion machines, letter insertion machines or packaging machines. The material web may be in the form of paper, fabric, card, plastic, metal, rubber or film, and so on.

### PRIOR ART

In processing machines of this type, in particular printing machines, a material web is moved along by driven shafts (web transport shafts or devices) such as, for example, pulling rolls or feed rolls and non-driven shafts such as, for example, direction-changing, guide, drying or cooling rolls. The material web is processed, for example printed, stamped, cut, folded, etc. at the same time by means of processing shafts, which are mostly likewise driven. The driven shafts influence both the web stress and the processing register, for example an ink or longitudinal register.

In the case of printing machines, for example, longitudinal and/or lateral registers are regulated in order to achieve an optimum printing result. Known regulators, such as, for example, P regulators, D regulators, I regulators, etc., as well as any desired combinations thereof include regulator parameters which must be adjusted. Normal regulator parameters are the proportional gain K_{P}, the integral gain K_{I}, the differential gain K_{D}, the adjustment time T_{N}, the lead time T_{V}, delays T, etc. In the prior art, the regulator parameters are determined and adjusted manually by evaluation of a step-function response. For this purpose, the reference variable is varied and the system response to this nominal-value change is investigated and optimized. A machine operator, for example, then changes the regulator parameters, for which reason he must have control-engineering knowledge and must adjust the parameters individually.

If the nature of the controlled system and its system parameters are known, calculated configuration is also possible, in addition to manual configuration. To do this, it is necessary to model the control loop under consideration. The control loop structure consists at least of the two elements the regulator and the controlled system (system response). The system response of an actuating movement for example of a printing mechanism is in this case normally modeled as a PT1 element with a delay time T(v)ₛ. For control engineering purposes, the system response is normally compensated for with the aid of a PI regulator, which results in a second-order system. There are various design criteria for the P gain and the I component in this case.

The time constant of the controlled system T(v)_{S} is in this case proportional to the material web length (between the shaft to be regulated and the previous clamping point), and is inversely proportional to the material web speed v. The material web length in this case typically remains constant during production and changes only when production changes are made, and it may be possible to assume it to be constant. This results in a simplification in that the system time constant is assumed to be proportional only to 1/v.

In the prior art, the regulator parameters are adapted using this speed-dependent time constant. Known adjustment methods are used in this case, such as, for example, symmetrical optimum or root-locus curve methods.

Continuous-time regulation is a regulation in which the regulator is calculated continuously, while in event-controlled regulation, the regulator is calculated at once only after a particular event. The corresponding event is in this case typically coupled to the measurement of a register error, and the measurement is generally carried out once, depending on the format/product. By virtue of the system, if the regulator parameters for event-controlled regulation are constant, this automatically results in the calculation being accelerated, rising in proportion to the machine speed, since more print marks are evaluated in each time unit at a higher machine speed, and more regulation processes are therefore carried out as well in each time unit. For continuous-time regulation, this can be modeled by a linearly rising I component (hyperbolically falling readjustment time). Fundamentally, because of this system-dependent change in the control response, event-controlled regulation is inherently stable.

Continuous-time regulation is subject to the problem that the system time constant is inversely proportional to the speed. This situation is overcome by adapting the readjustment time in proportion to 1/v. Alternatively, the P gain K_{P} for a PI regulator for which R=K_{P}(1+1/T_{N}) can be adapted using 1/v.

The known methods have the disadvantage that, on the one hand, the regulator parameters must be entered manually, which normally does not lead to optimum regulation, while on the other hand the methods for automatic adaptation are not yet sufficiently proven to achieve optimum results, in particular with respect to the disturbance response.

Against this background, the present invention proposes a method for modeling a control loop for a processing machine, a computation unit, a computer program and a computer program product having the features of the independent patent claims. Advantageous developments are the subject matter of the dependent claims and of the following description.

In the method according to the invention for modeling of a control loop for a processing machine for processing a material web, in particular a printing machine without a shaft, the modeling takes account of at least one, in particular constant dead time, that is to say a dead time which is not dependent on the web speed and/or speed.

Therefore, according to the invention, the modeling of the fundamental control loop also for the first time takes account of a dead time, in addition to the system response, which is normally modeled by means of a quotient of the material web length and the material web speed and is characterized by a web-speed-dependent delay time T(v)_{S}.

### ADVANTAGES OF THE INVENTION

The solution according to the invention makes it possible to model the control loop on which a processing machine is based such that the model is optimized in comparison to the prior art. No dead times are taken into account in the prior art. However, according to the invention, constant and/or speed-dependent dead times are now taken into account in order to achieve good results in all speed ranges. By way of example, a speed-dependent dead time normally has a major influence at low speeds, and this influence decreases as the web speed increases. However, particularly in this speed range, constant dead times actually have a particularly disturbing influence since, by definition, they are not dependent on the speed, and can thus dominate the system response in these speed ranges. The control loop modeled by means of the invention can be used to determine the regulator parameters, in particular automatically, using known methods. The regulator parameters are therefore optimally matched to the processing machine on which they are based, and there is no need for any manual input by a user. This precludes a significant error source in setting up the machine.

The at least one constant dead time advantageously includes a data transmission time from a sensor to a computation unit, a measurement time and computation time of a sensor, and/or a computation time of a computation unit. If the processing machine is in the form of a printing machine, in particular a gravure printing machine, the sensors (register and/or web stress sensors) are normally arranged at a certain distance from the responsible controller. A dead time which can advantageously be considered accordingly results from the transmission time between a sensor and the computation unit to which the sensor is connected. By way of example, the measured values can be transmitted from the sensors to the controllers via a network or via a fieldbus. A further dead time, which can advantageously be taken into account, results from a measurement time of a sensor. This dead time is defined by the time interval which the sensor requires in order to produce the measurement signal at a sensor output from the time at which the mark reaches the sensor.

This can include internal processing, for example a calculation and provision of a position or a distance. Finally, a computation unit which is used also includes a dead time which is defined by the time interval between the reception of the measured value from the sensor and the output of the actuating value to the controlled system. The sum of the constant dead times is typically in the range from 10 to 200 ms. It is expedient if one or all of said dead times can be entered from the outside, can be determined automatically, or can be checked via a bus system. By way of example, data transmission times can be determined using time synchronization methods. Measurement times and computation times can be measured.

According to one preferred refinement, at least one speed-dependent dead time is taken into account in the modeling. It is possible to model the at least one speed-dependent dead time as a function of a processing length and a web speed. By way of example, a speed-dependent dead time results from the fact that an actuating command does not act immediately on the computation unit of the regulator. For example, an angular displacement of a cylinder does not occur suddenly, but is distributed in the form of a ramp over the revolution of the printing cylinder. This results in a soft displacement, which has only a slight effect on the printing process and web transport. This distribution of a displacement in the form of a ramp can, for example, be modeled as a dead time. Furthermore, speed-dependent dead times result from the event for the controlled regulator being sampled at discrete times. By way of example, on a printing machine, the regulator normally receives a new measured value to determine the control error only once per printing cylinder revolution. One or both already mentioned dead times can be modeled as a function of a processing length and a web speed, in which case, in particular, it is possible to use a proportionality to the quotient of the processing length and the web speed, or to the quotient of the processing length and twice the web speed. By way of example, a printing length, for example the distance between two identical register marks on a material web, is referred to as a processing length.

The at least one speed-dependent dead time is advantageously modeled as a function of a distance between a sensor and a printing mechanism. It is also possible for the modeling to be carried out as a function of the reciprocal web speed. It is also possible to enter the distance between the sensor and the printing mechanism, or to determine this automatically. The sensor is normally not located immediately adjacent to the printing mechanism but, for example, up to several cylinder circumferences behind the printing mechanism, in order to detect the register marks. The distance through which the material web must travel before the sensor can detect a register mark can be modeled as an additional dead time, which decreases as the speed increases.

According to one advantageous embodiment of the invention, the at least one constant dead time and/or the at least one speed-dependent dead time are combined in a control loop element. This control loop element can be modeled, for example, as a PT1 element. This allows all the dead times taken into account to be taken into account as a total dead time within the control loop, which particularly simplifies the modeling of the control loop. Therefore, depending on the embodiment of the invention, the control loop element includes a material web speed, a material web length, that is to say the length between two processing devices, a processing length, that is to say the distance between two repeated processing points on the material web, a distance between a sensor and a processing device, a data transmission time from a sensor to a computation unit, a measurement time of a sensor and/or a computation time of a computation unit. This refinement of the invention offers the advantage that all the variables included are either geometric or physical parameters of the processing machine which have to be determined only once, or are parameters such as, for example, the material web speed, which are known or can easily be determined within the machine.

Regulator parameters are expediently determined on the basis of the modeled control loop. In particular, this determination can be carried out automatically within a computation unit such as, for example, a controller or a register regulator. This preferred refinement of the invention therefore makes it possible to configure the regulators optimally and automatically at any time during processing by a processing machine.

The regulator parameters are expediently designed with respect to the disturbance response. In typical register regulating processes, the nominal value of the register regulator is adjusted by the operator only rarely during the printing process. For this reason, the regulator has the function rather more of regulating out disturbances which occur (=controlled error) during the printing process. The design of the regulator parameters should therefore take greater account of the situation in which disturbances occur, rather than that of a nominal value change. When the optimization strategies (sudden nominal value changes and disturbance response) are compared, higher P gain levels generally occur for optimization on the basis of the disturbance response, in order to more quickly regulate out errors which occur and which, furthermore, generally do not occur suddenly, but are created rather slowly. When a sudden nominal value change is then applied to such regulators, this can lead to major overshoots and therefore to a poor regulation performance. A sudden nominal value change can also be caused by the nominal value being changed by the operator. It is advantageous to optimize for the disturbance response, with the reference response expediently being optimized by suitable prefiltering (for example by means of a PT1 filter upstream of the subtraction point) of the reference value, in order in particular to minimize the tendency to oscillate. When nominal value changes occur, the prefilter is used to pass these changes to the control loop with reduced dynamics in order, for example, not to drive the regulator into a limiting state. This would in turn lead to non-linearities and, in contrast, to reduced dynamics, or even to a tendency of the control loop to oscillate.

The regulator parameters can be determined as a function of a family of characteristics. As has already been explained further above, only a small number of changing variables are included as parameters in the modeling, while in contrast a large number of variables are fixed, such as, for example, distances, constant dead times, etc. For this reason, families of characteristics can be produced as a function of the changing variables, such as, for example, the material web speed, and these families of characteristics can, for example, be stored in a memory device in the computation unit. This makes it possible to significantly speed up the automatic configuration of the regulators.

Particularly from the programming point of view, a computation unit according to the invention is designed to carry out a method according to the invention.

The invention furthermore relates to a computer program having program code means in order to carry out all the steps for modeling and, if appropriate, for configuration of a control loop using a method according to the invention, when the computer program is run on a computer or an appropriate computation unit, in particular in a processing machine.

The computer program product which is provided according to the invention and has program code means which are stored in a computer-legible data storage medium is designed to carry out all the steps for modeling and, if required, configuration of a control loop using a method according to the invention, when the computer program is run on a computer or an appropriate computation unit, in particular in a processing machine. Suitable data storage media are, in particular, floppy disks, hard disks, flash memory, EEPROMs, CD-ROMs, DVDs, etc. It is also possible to download a program via computer networks (Internet, Intranet, etc.).

Further advantages and refinements of the invention will become evident from the description and the attached drawing.

It is self-evident that the features mentioned above and those which are still to be explained in the following text can be used not only in the respective stated combination but also in other combinations or on their own without departing from the scope of the present invention.

The invention will be described in detail in the following text, with reference to the drawing, and is illustrated schematically in the drawing, on the basis of exemplary embodiments.

### DESCRIPTION OF THE FIGURES

FIG. 1 shows a schematic illustration of a processing machine which is in the form of a printing machine and for which the method according to the invention is suitable;

FIG. 2 shows a schematic illustration of a control loop, modeled according to the invention, for a processing machine;

FIG. 3 shows a control loop as shown in FIG. 2, in the form of a transformed, quasi-continuous illustration; and

FIG. 4 shows a simplified illustration of the control loop shown in FIG. 3.

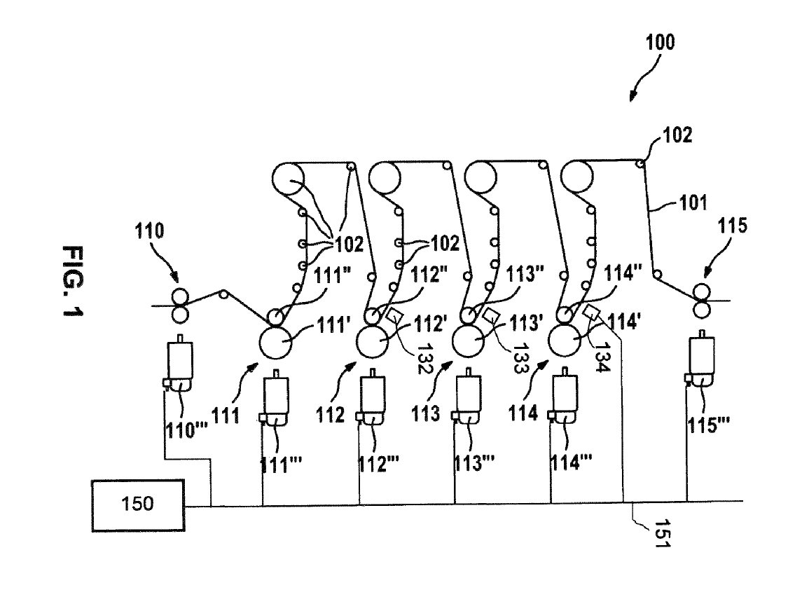

In FIG. 1, a processing machine in the form of a printing machine is annotated 100 overall. A printing material, for example paper 101, is supplied to the machine via a feeding mechanism (infeed) 110. The paper 101 is passed through processing devices in the form of printing mechanisms 111, 112, 113, 114, is printed, and is output again through an output mechanism (outfeed) 115. The feeding, output and printing mechanisms are arranged such that they can be positioned, and in particular can be corrected in cylinder and angle. The printing mechanisms 111 to 114 are located in an area where the web stress is regulated between the feeding mechanism 110 and the output mechanism 115.

The printing mechanisms 111 to 114 have respective printing cylinders 111′ to 114′ against which a respective presser 111″ to 114″ is pressed with a strong pressure. The printing cylinders can be driven individually and independently. The associated drives 111′″ to 114′″0 are illustrated schematically. The pressers are designed so that they can rotate freely. Together with the paper 101 passing through, the printing mechanisms 111 to 114 each form a unit (clamping point) connected by a friction link. The drives of the individual mechanisms are connected to a controller 150 via a data link 151. Furthermore, a plurality of sensors 132, 133, 134 for detection of register marks are located between the printing mechanisms, and are likewise connected to the controller 150. For clarity reasons, the figure shows only one sensor 134 connected to the controller. In particular, the controller 150 includes a refinement of a computation unit according to the invention, and is designed for automatic regulator configuration.

The paper 101 is passed over rolls in the web sections between the individual printing mechanisms 111 to 114, which rolls will not be explained in any more detail, but are annotated 102. For clarity reasons, the rolls are not all provided with reference symbols 102. In particular, they may be direction-changing rolls, drying, cooling or cutting devices, etc.

The following text describes how register and/or web stress regulation are/is carried out in the illustrated printing machine. The sensors 132, 133, 134 are arranged in the individual web sections between the printing mechanisms 112 to 114, determine the register positions of the material web 101 and for this purpose are, for example, in the form of mark readers. When the material web 101, for example paper, passes through, a mark reader in each case detects when a printing mark (not shown), which is preferably applied by the first printing mechanism 111, reaches the mark reader. The measured value is supplied to a device for register regulation (register regulator). The position of the corresponding printing cylinder 112′ to 114′ is then detected, and this measured value is likewise supplied to the register regulator. A respective register error can be calculated from this (web/cylinder correction). The register errors found are used for positioning of the printed mechanisms 112 to 114, and preferably also for positioning of the feeding mechanism 110 and the output mechanism 115.

Alternatively, the mark reader can measure positions and short mark separations of all the previously applied registered marks, and can supply these to the device for register regulation. A respective register error between applied register marks can be calculated from this (web/web correction), and can be used for positioning of the printing mechanism 111 to 114, and preferably also for the positioning of the feeding mechanism 110 and the output mechanism 115.

Alternatively or additionally, the web is preferably provided with a first sensor between the feeding mechanism 110 and the first printing mechanism 111, and with a second sensor between the last printing mechanism 114 and the output mechanism 115, which sensors are in the form of web stress sensors. Web stress values detected by the sensors (not shown) are supplied to a device for web transport regulation (tension regulator). The tension regulator controls the drives 110′″ and 115′″ of the feeding mechanism 110 and of the output mechanism 115, advantageously as well as the drives 111′″ to 114′″ of the printing mechanisms 111 to 114, as a function of the web stress values.

According to the illustrated embodiment, the register regulators and/or tension regulators are configured automatically using a method according to the invention. It is self-evident that the already mentioned tension regulators and register regulators can be embodied in a common computation unit 150, for example a computer.

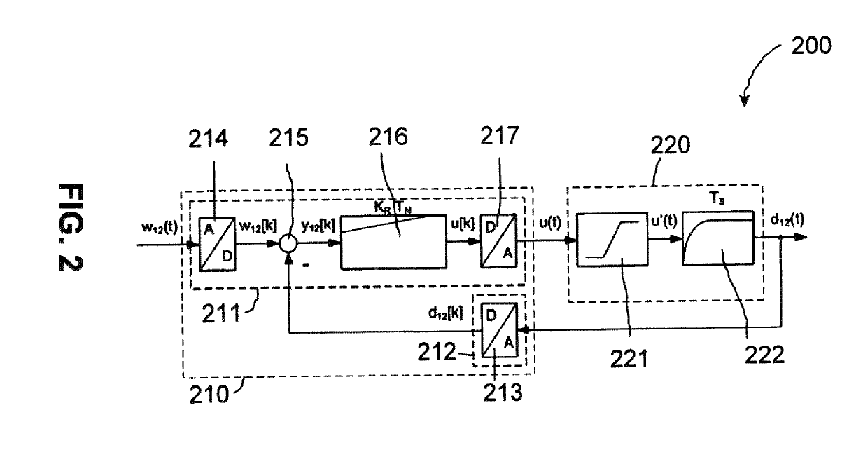

A control loop modeled according to the invention is illustrated schematically, and is identified overall by 200, in FIG. 2. By way of example, a printing machine as shown in FIG. 1 may form the basis for the control loop. Because of the characteristics of the processing machine on which this is based, the control loop 200 can be subdivided into a discrete-time component 210 and a continuous-time component 220. An element 221 which models the ramp-like displacement of the printing cylinders in reaction to an actuating command u(t) is located in the continuous-time component 220. The actuating command u′(t), which is modeled like a ramp, is passed onto the controlled system 222 with the system time T_{S}.

The discrete-time part 210 comprises a part 211 which is contained in a register regulator, for example a PLC, and a part 212, which is contained in a sensor. The sensor is modeled by an analog/digital element 213, which supplies the continuous controlled variable d₁₂(t) to a comparison point 215 as the discrete-time feedback variable d₁₂[k].

The register regulator part 211 likewise comprises an analog/digital element 214, which calculates the discrete-time reference variable w₁₂[k] from the continuous reference variable w₁₂(t). The comparison element 215 calculates the discrete-time control error or the control difference y₁₂[k], which is supplied to the actual control element 216. The control element 216 is in the form of a PI element. The continuous-time manipulated variable u(t) is calculated in a digital/analog element 217 from a discrete-time regulator output variable u[k].

Both constant and speed-dependent dead times are now taken into account in the control loop 200 according to one particularly preferred embodiment of the invention. The controlled variable d₁₂(t) is detected by a sensor, for example with an area of the material web on which the printed register marks are located being illuminated by means of an LED. An optical unit detects a register mark and transmits the measurement signal to an electronic evaluation unit which, for example, identifies the register mark by color, and can calculate the distance between two register marks of different color. The overall process as described requires a measurement time which is taken into account as the dead time T_{t,SENSOR} and which may, for example, be 10-100 ms. This dead time is associated with the element 213.

The feedback variable d₁₂[k] is supplied via a connecting line to the register regulator, which requires a certain transmission time, which is taken into account as a further dead time T_{t,NET}. This varies in the range from about 1 to 20 ms. Finally, the register errors y₁₂[k] and the manipulated variable u[k] are calculated in the register regulator, for example a PLC, which in turn leads to a dead time T_{t,PLC} which is about 1-20 ms.

According to the described refinement of the invention, these constant dead times are taken into account in addition to speed-dependent dead times, which are normally modeled as being proportional to a ratio of length and material web speed.

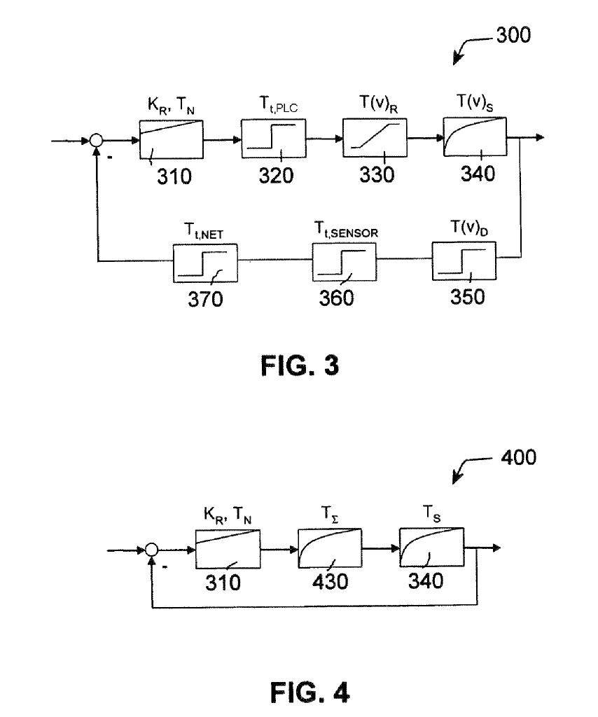

According to a further preferred refinement of the invention, the dead times just described are combined within the control loop in a control loop element, as described in more detail with reference to FIG. 3.

FIG. 3 shows a simplified illustration of the control loop shown in FIG. 2, which is annotated 300 overall. The individual control loop elements are shown in this illustration.

The control loop 300 comprises a PI element 310 with a control gain K_{R} and a readjustment time T_{N}. The constant dead time which results from the computation time of the computation unit is represented by the dead time T_{t,PLC} in a dead time element 320. The speed-dependent dead time T(v)_{R}, which is caused by the ramp response of the manipulated variable, is modeled in an element 330. The system response with the speed-dependent system times T(v)_{S} is, finally, modeled in a PT1 element 340.

The speed-dependent dead time T(v)_{D} occurs first of all in the feedback, caused by the distance between the sensor and the printed mechanism. This dead time is modeled in a dead time element 350. The constant dead time T_{t,SENSOR} caused by the measurement time of the sensor is modeled in a dead time element 360. The constant dead time T_{t,NET} caused by the data transmission is modeled in a dead time element 370.

According to a further preferred embodiment of the invention, the dead time elements 320, 330, 350, 360 and 370 just described are combined in a controlled loop element, as is described with reference to FIG. 4. FIG. 4 shows a further simplified illustration of the control loop shown in FIG. 3, which is annotated 400 overall. The control loop 400 now comprises the PI element 310 and the controlled system 340 from FIG. 3. The dead time elements from FIG. 3 are combined in a control loop element 420, which is characterized by a total dead time T_{S}.

The control loop element 420 can be adapted by means of a PT1 response. It is self-evident that other control-engineering adaptations are also possible. The position of the control loop element 420 within the control loop 400 can be chosen by the responsible person skilled in the art. By way of example, the control loop element 420 can also be arranged in the feedback path.

It is self-evident that the figures represented illustrate only exemplary embodiments of the invention. In addition, any other embodiment is feasible without departing from the scope of this invention.

### REFERENCE SYMBOLS

100 Printing machine
101 Paper web
110 Feeding mechanism
111-114 Printing mechanism
111′-114′ Printing cylinder
111″-114″ Presser
111′″-114′″ Drive
115 Output mechanism
132, 133, 134 Register mark sensor
150 Controller
151 Data link
200 Control loop
210 Discrete-time component
220 Continuous-time component
221 Ramp element
222 Controlled system
211 PLC
212 Sensor
213, 217 Digital/analog element
214 Analog/digital element
215 Comparison element
216 PI element
300 Control loop
310 PI element
320 Dead time element
330 Ramp element
340 Controlled system
350, 360, 370 Dead time element
400 Control loop
430 Total dead time element

1. A method for modeling a control circuit of a shaftless printing machine which is configured to process a material web comprising:
modeling at least one dead time.

2. The method as claimed in claim 1, wherein the at least one dead time comprises at least one constant dead time.

3. The method as claimed in claim 2, wherein the at least one constant dead time includes a data transmission time from a sensor to a computation unit, a measurement time of a sensor and/or a computation time of a computation unit.

4. The method as claimed in claim 2, wherein the at least one dead time further comprises at least one speed-dependent dead time.

5. The method as claimed in claim 4, wherein the at least one speed-dependent dead time is modeled as a function of a processing length and a web speed.

6. The method as claimed in claim 4, wherein the at least one speed-dependent dead time is modeled as a function of a distance between a sensor and a printing mechanism.

7. The method as claimed in claim 4, wherein the at least one constant dead time and the at least one speed-dependent dead time are combined in a control loop element.

8. The method as claimed in claim 7, wherein a web speed, a material web length, a processing length, a distance between a sensor and a processing device, a data transmission time from a sensor to a computation unit, a measurement time of a sensor and/or a computation time of a computation unit are included in the control loop element.

9. The method as claimed in claim 1, further comprising:
determining regulator parameters for a regulator based on the at least one dead time.

10. The method as claimed in claim 9, wherein the regulator parameters are configured with respect to a disturbance response.

11. The method as claimed in claim 9, wherein a reference response is optimized by prefiltering of a reference variable with a PT1 filter.

12. The method as claimed in claim 9, wherein the regulator parameters are determined as a function of a family of characteristics.

13. The method as claimed in claim 9, wherein the functionality of the regulator is web stress regulation and/or register regulation.

14. The method as claimed in claim 1, wherein the shaftless printing machine is a gravure printing machine or flexographic printing machine.

15. (canceled)

16. (canceled)

17. (canceled)

18. A web material processing system comprising:
a process path along which a web material is moved;
a regulator configured to regulate a condition of the process path;
a memory in which command instructions are stored; and
a processor configured to execute the command instructions to
characterize the in-process movement of the web material moving along the process path by modeling at least one dead time of the system,
determine at least one regulator parameter based upon the at least one dead time, and
control the regulator based upon the determined at least one regulator parameter.

19. The system of claim 18, wherein the at least one dead time comprises a first dead time that does not vary with a change in speed at which the web material moves along the process path.

20. The system of claim 19, wherein the at least one dead time further comprises:
at least one speed dependent dead time which varies based upon the speed at which the web material moves along the process path, wherein determination of the at least one regulator parameter is based upon a determined speed at which the web material moves along the process path.

21. The system of claim 20, wherein the regulator is a stress regulator.

22. The system of claim 20, wherein the regulator is a register regulator.

23. The system of claim 18, wherein a first of the at least one dead time is a computation time dead time.

24. The system of claim 23, wherein a second of the at least one dead time is a measurement time dead time.
